(19) United States
(12) Patent Application Publication
(10) Pub. No.: US 2003/0085818 A1
(43) Pub. Date: May 8, 2003

(54) System and method for acquiring, storing, processing and presenting data accumulated through an in-flight aircraft server

(76) Inventors: Joseph J. Renton, Orange, CA (US); Eric M. Hicks, Anaheim Hills, CA (US); William M. Isley, Covina, CA (US); Steven S. Hawkins, San Dimas, CA (US)

Correspondence Address: PRICE AND GESS, Suite 250, 2100 S.E. Main Street, Irvine, CA, 92614, US

(21) Appl. No.: 10/241,381

(22) Filed: Sep. 9, 2002

Related U.S. Application Data
(60) Provisional application No. 60/318,066, filed on Sep. 7, 2001.

(51) Int. Cl. G08B 21/00

(52) U.S. Cl. 340/945

(57) ABSTRACT

A system and method of acquiring, processing and presenting data gathered by an in-flight aircraft server, used for in-flight entertainment, for example, provides for off-loading and secure online storage of various forms of data for each authorized user. The system supports customization as dictated by the proprietary data formats of authorized users. Through a dedicated website, data from aircraft is uploaded, converted to a usable format and archived into a uniquely structured database. Through the website, an authorized user may generate reports based on the achieved data which may contain charts, graphs, calculated statistical information, a conversion of the data to a common format like a Microsoft Word or Excel document, for example.

### CROSS REFERENCE TO RELATED APPLICATIONS

This application claims the benefit of the filing date of provisional application No. 60/318,066 filed Sep. 7, 2001 for System And Method For Acquiring, Processing, Storing, And Presenting Data Accumulated Through In-Flight Entertainment Systems. The entire contents of the above-identified provisional application is incorporated herein by reference.

### BACKGROUND OF THE INVENTION

1. Field of the Invention

The present invention relates generally to improvements in data acquisition and analysis systems and more particularly pertain to new and improved systems and methods for acquiring, processing and presenting data for individual authorized users of the system in a user-defined format with communication between an individual user and the system is over the internet.

2. Description of the Prior Art

The system and method of the present invention finds particular applicability to the acquisition, storing, processing and presentation of accumulated data from in-flight entertainment (IFE) systems that have been developed and used primarily on international commercial passenger airliners to entertain the passengers during the long international flights. These IFE systems typically include a server that serves media such as audio, video, or web pages to terminals at the individual passenger seats. These servers also typically collect data relating to the use of the media provided to the passengers. Information such as which audio segments, video segments or web pages are being viewed by the passengers. Data gathered in other business domains such as web site traffic analysis, consumer buying pattern analysis, project expense analysis or any other domain that requires reporting analysis of raw data could also be the source of information that that the system of the present invention is capable of processing.

In the field of acquiring an analyzing data for usage, or for any other reason, it has been the practice to employ procedures that were cumbersome for individual users or customers of the service providing the analysis. The present invention, on the other hand, by employing a website accessible by each authorized user readily allows that authorized user to easily up-load his data from a PC, over the internet. The system converts the data to a usable format and archives it into a server structured database. From his PC, an individual user can quickly and easily generate reports based on his stored data in a variety of predetermined and customized formats after logging on to the website interface.

### SUMMARY OF THE INVENTION

A system and method for gathering and processing data generated by an in-flight aircraft computer system using a data collection means and a processor for extracting data from the in-flight information gathered by the aircraft computer system during flight. The extracted data is communicated by way of a dedicated website to a storage module which is uniquely configured for the extracted data and the authorized users of the system. The data stored in the storage module is used by a data presentation processor under the control of an authorized user to produce reports in a variety of prearranged or custom formats using the data in the configured storage module. The reports could include graphics such as 2D, and 3D bar charts, 2D and 3D pie charts, as well as a variety of table and statistics formats. The statistics formats could display usage statistics, in-flight passenger survey statistics or errors logged by the in-flight system. The system of the present invention reminds the authorized user of missing data, such as the acquired data from a certain flight being missing, if it has not been uploaded into the system within a certain period.

### BRIEF DESCRIPTION OF THE DRAWINGS

The exact nature of this invention as well as its objects and advantages will become apparent to those skilled in the art upon consideration of the following description of a preferred embodiment of the invention as illustrated in the accompanying sheets of drawings in which:

FIG. 1 is a block diagram of a system according to a preferred embodiment of the invention;

FIG. 2 is a block diagram of the top level functional features of the data warehouse and user interface of the present invention;

FIG. 3 is a flow diagram illustrating the user interface flow according to the present invention;

FIG. 4 is a block diagram illustrating the report creation database schema according to the present invention;

FIG. 5 is a block diagram illustrating the usage statistics database schema according to the present invention;

FIG. 6 is a block diagram illustrating the in-flight passenger survey database schema according to the present invention; and

FIG. 7 is a block diagram illustrating the in-flight entertainment system graphic user interface error log database schema according to the present invention.

### DETAILED DESCRIPTION OF THE PREFERRED EMBODIMENT

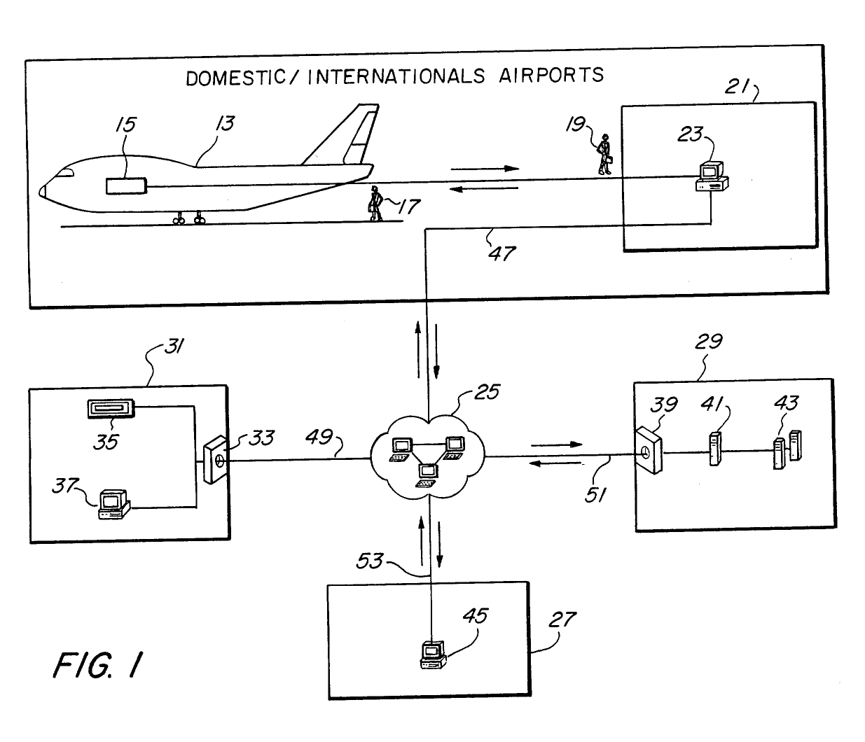

FIG. 1 is a block diagram illustration of a preferred embodiment of the system according to the present invention. Information for an in-flight entertainment (IFE) server 15 located on an international aircraft 13 located at an airport may be loaded into the server 15 by a technician 17 carrying data on a disk for insertion into the IFE server. Likewise, data may be downloaded from the server 15 by a technician 19 by inserting an empty data disk into the server 15 and downloading the desired information from the server 15 onto the disk. The disk is then carried by technician 19 to an airline maintenance facility 21 for example, at the airport which would have an airline PC workstation 23 capable of reading the downloaded information on the data disk. This airline workstation through its browser software would, over telephone network 47, the internet 25 and lines 51 upload the information downloaded, IFE server 15 to a remotely located data warehousing center 29. The warehousing center 29 contains a structure firewall 39 from the webserver 41, and a plurality of database servers and storage 43.

The authorized user is typically an airline company 45 like American or United, for example, which would have other PC workstations at other airline facilities 27 throughout the country that are connected to the internet 25, perhaps over a high speed data line 53. This workstation 45 could access by way of the internet and another high speed data line 51, the facilities of the systems' data warehousing center 29. Access to the database server and back-up storage 43 for the airline authorized user is through a web-based server 41 which is behind the security requirements of a firewall structure 39.

A network operation center 31 is operated by the company providing the data gathering and presentation services to the authorized user airline. The data warehouse facility 29 is also established and maintained by the company providing the contract to the airline. User network operations center 31 contains a firewall structure 33 that prevents unauthorized entry to the operations center 31 but which allows connection over a high speed network 49 to the internet 25 and to the data warehousing facility 29. The network operations center 31 includes a tape back-up unit 35 for storing any data retrieved from data warehousing facility 29 as needed and a network monitor 37 for accessing the web server 41, and the data server and back-up storage modules 43 in the data warehouse center.

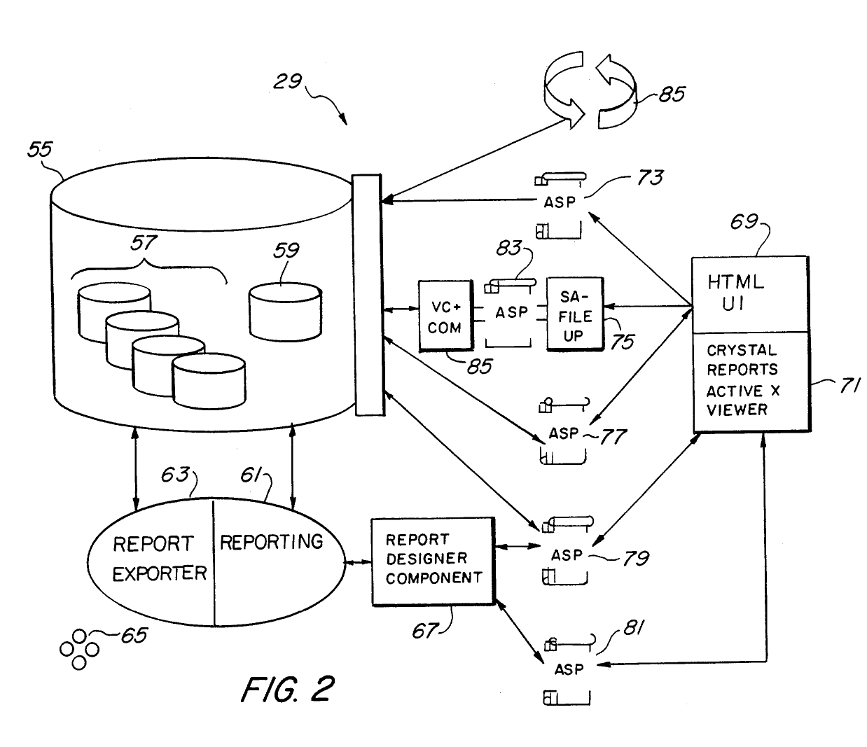

The services provided to the airline authorized user for example, is provided to the user through a web-based user interface (UI). Referring now to FIG. 2, the UI 69 is built in HTML/DHTML and JavaScript. That may, for example, be Internet Explorer 4.0+ and Netscape 4.7+ (on Windows 98+ platform) compatible. Active Server Pages (ASP) 73, 83, 77, 79, 81 scripts on a Microsoft Windows 2000 Advanced Server machine running Internet Information Server 5.0 processes the form data submitted from the HTML user interface 69. The user interface allows the user to log in (ASP 73), upload data files (ASP 83), generate and export a report (ASP 81), create or edit ad hoc reports (ASP 79) and administer the account (ASP 77).

The data warehouse 55 illustrated in FIG. 2 includes a collection of MicroSoft SQL Server 2000 databases. A separate database or data mart 57 is created for each subscriber to the service, such as an airline, for example, who then designates a plurality of individual authorized users of the system that are authorized to access data storage. A separate metadata database 59 is used to store information about the authorized user, information about how to extract information from the uploaded data files, information about how to insert the extracted data into the user's data mart 57 and information about how to generate the reports requested against the user's data mart 57.

Each authorized user's data mart 57 is a Microsoft SQL server 2000 database schema that houses the information uploaded by a specific user. All references to the data mart necessary to create a connection with the database, perform a query and generate a report by that authorized user stored in the metadata database 59.

The database schema for an authorized user's data mart is designed and implemented based upon data definitions and relationships provided by the authorized user. Stored procedures are used for populating the data mart of the authorized user from uploaded data file information. The appropriate references to the data mart are added to the metadata database 59. The data mart 57 is created by SQL script and are reused if another subscribing authorized user entity requires storage of similar data. Even though the schema is reused, a separate database is created for each separate authorized user entity.

The metadata database 59 is a MicroSoft SQL Server 2000 database that stores all the information pertaining to a user of the data warehouse functions such as user log-in, password, available reports, and dispatching information for the data extractor. It contains all references to the user data mart 57 required to perform a query or generate a report. The metadata database 59 also contains any information necessary for data mart management. In addition, the metadata database contains the user interface customization information such as the user's color scheme and the user's custom logo.

An authorized user inserts data into his specific data mart 57 uploading data files from an HTML form. SA-FileUp 75, a third party Internet Server Application Programmer Interfaced Dynamically Linked Library (ISAPI DLL) accepts the data file submitted and stores it on the server. SA-FileUp 75 provides progress indication on the status of an uploaded file by firing status to a progress ASP script 83. Information such as total file size, the file name and the percent loaded so far is provided by the fire status which allows a display of a progress bar by an HTML page in a pop-up window that refreshes after each status is fired. Once the entire file is loaded the progress bar window waits five seconds and then closes.

A data extractor 85 is preferably a component ASP Object Model (COM) DLL combination that prepares and performs the parsing of the uploaded data file. If the uploaded data file must be extracted from a zip file, or any other preparation must be done to the file to bring it to a state where it can be parsed, the data extractor 85 performs these operations. The data extractor 85 is also responsible for parsing the file and inserting it into the appropriate data mart 57. Insertion into the data mart 57 are performed by MS SQL Server Stored Procedures.

The authorized user defines the format of the data file that is used to insert data into its data mart 57. The necessary data extraction, parsing, an database insertion routines are then written into the data extractor 85, if the routines do not already exist. Database insertions are done by Stored Procedures. The Data Extractor 85 is called from an ASP script 83 as the result of a data file upload. References are added to the metadata database 59 so that the systems knows which data extraction routine to use for that particular data file. If the uploaded data file is a set of data files compressed into a zipped file, the InfoZip function and Application Programs Interface are used to unzip the files.

The reporting engine 61 of the system is Crystal Reports 8.5 Developer Edition 65. Crystal Report's wizards are used to predefine the reports that authorized users can run against their data. References to the available predefined reports are stored in the metadata database 59. An ASP script drives the process of running the Crystal Reports reporting engine 61 and displaying the report in the appropriate location in the user interface 69. The reports may include statistical information, charts, graphs, and tables.

A set of predefined Crystal Reports, created with Crystal Reports 8.5 Developer Edition 65, exists for each type of data housed in the data warehouse 55. An authorized user can request that additional predefined reports, designed by the authorized user, created by a service representative for the system be added for his use. References exist in the metadata database 59 for defining the access each user has to a particular report. These reports are reused if another authorized user requires storage and reports on a similar data.

A Crystal Reports ActiveX Viewer 71 component is used in the system to view reports as well as export the reports to a variety of formats. The Crystal Reports ActiveX Viewer 71 can export a report to a MicroSoft word document, MicroSoft Excel document, or an Adobe PDF document, for example. It also has the ability to print and report straight from the user interface 69.

A report creator through ASP 79 allows the customization of a set of report types into a user defined report. From an implementation perspective, a report type is a superset of data returned by the Report Exporter 63 in response to a database query. Examples of report types are Digital Video Usage Report, Passenger Survey Report, and Analog Audio Usage Reports.

The report creator uses the Crystal Reports Report Designer Component 67 to create Crystal Reports Report files based on user specifications set in the “Create A Report” user interface 69. This feature allows the authorized user to add a graph to a report, discriminate against the data return by the report, set the fields to be displayed in the report, set the format of the report, and create a Crystal Reports report file (RPT).

An Account Administrator through ASP 77 allows the authorized user to create and administer the system for his company. Access can be set, granted, or removed for the Main Menu, Data Upload, Generate a Report, or Create a Report functions for each authorized user. Access to individual reports can also be set by the account administrator.

User access levels are stored in the metadata database 59. Before loading any screen that has possible access restrictions, the metadata database 59 is queried to verify the user's access. Any functionality that the user does not have access to is not displayed on the screen. By default, when the authorized user creates a user, the user does not have right to view any reports or perform any functionality.

The account administrator can also set effectivity dates for its data and monitor the amount of data stored. Data stored in the authorized user's data mart 57 with an expired effectivity date will be moved to a temporary data mart archive upon insertion of new data. This temporary data mart archive is a separate SQL Server database that is created for each authorized user that subscribes to the service. The migration of the data with expired effectivity is accomplished by the stored procedures that are used to insert new data. This temporary data mart archive is backed up to tape at the end of each month in the native SQL Server backup format and purged from the database.

An upload reminder 87 e-mails the account administrator if data is missing from the brand account's data mart. For example, if a set of data is missing from the authorized user's data mart, the upload reminder 87 e-mails the address specified by the authorized user and identifies the set of data that is missing. The upload reminder 87 is a Windows service that runs on the web server. Every night at midnight, for example, the upload reminder 87 queries all data mart 57 for missing data, e-mailing the brand administrator if missing data is discovered

Parameters can be set by the account administrator specifying the e-mail address the upload reminder 87 is to use, length of time that can pass with missing data before sending an e-mail, and the frequency of the reminder. These set parameters are stored in the metadata database 59. The reminders can be set to e-mail each day until the data is uploaded or once every N days, where N is a number specified by the authorized user Account Administrator.

The code that parses uploaded data files and inserts the data into the database 55 is compiled into a COM DLL, extractorpdj.dll that exposes one interface, IExtractor which contains the modules: Initiate, Extract, Parse Files and Insert Into Database.

The web-based user interface (UI) 69 encompasses all of the HTML scripts that are accessible to the users. It also contains portions of the user database and ASP scripts used to customize the color scheme of the UI for each authorized user and add in the branded user logo banner.

A variety of screens may be seen by the authorized user of the system: A login screen, which provides fields for the authorized user to enter a login name and password. A main menu screen, that appears when the authorized user logs into the system. This screen also provides a listing of the menu options available to the authorized user. A data upload screen which provides a field and a file system dialog for the authorized user to select the data file he wishes to upload. The user interface also allows the authorized user to select between the different types of file formats that can be used to upload the data. An upload progress screen which is merely a pop-up window that displays a progress bar indicating the percentage of the data file that is uploaded so far. A report generation screen that lists all reports that the authorized user has access to as well as the parameters that can be set on the data to discriminate against the data returned by the report. Examples of parameters that can be set for uploaded in-flight entertainment data are: flight number, flight date, or tail number. These parameters can be set to generate a report for a specific flight, or a specific tail number, or both. The parameter values selected by the authorized user are passed to the Crystal Reports 65 as a selection formula. The selection formula narrows down the data displayed in the selected report. By selecting the desired values of available parameters, the selection criteria of the data that is represented in the report is tailored to only the data the authorized user wishes to see in the report. A report display screen is an HTML page with the Crystal Reports ActiveX Viewer embedded into it. The Crystal Reports ActiveX Viewer 71 directly communicates with the Crystal Reports web components to generate the reports. The ActiveX Viewer 71 provides the functionality to display reports, export reports to the client machine, refresh the data in the report, magnify the view of the report, or print the report. An administrator accounts screen allows the user to change their login password, as well as set administration options. An ad-hoc report creation screen allows the authorized user to define a report that they wish to run against their data mart. A flight information modification screen allows the authorized user the ability to modify invalid flight data uploaded to the data mart.

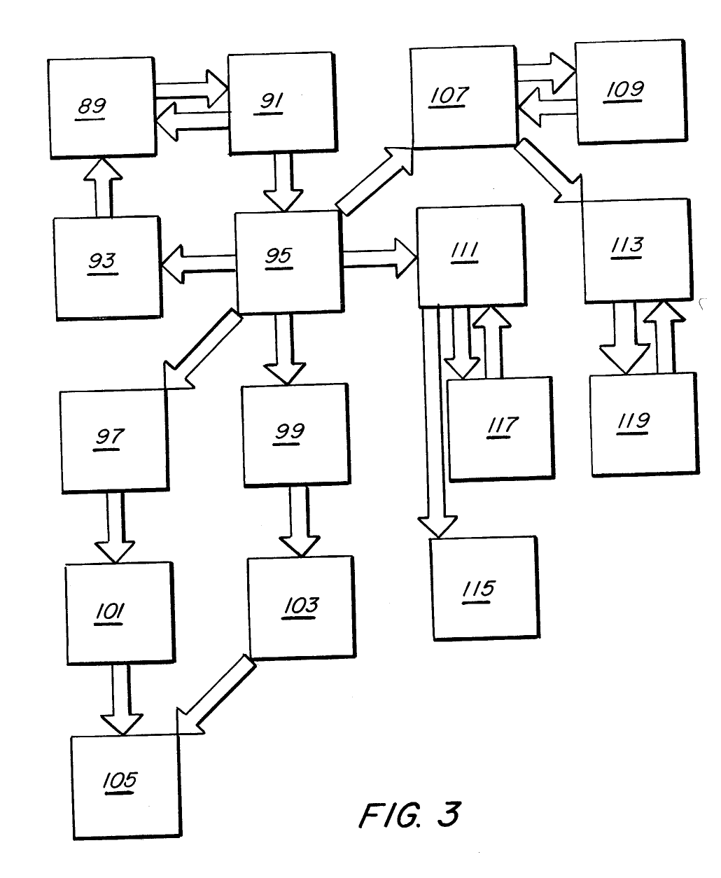

FIG. 3 diagramatically illustrates the user interface screen flow for the web server. Each box represents an ASP script that resides on the server. The user interface pages have ASP script and HTML and the processing pages are pure ASP. A user interface page does processing on the server and returns an HTML document to the client browser. The processing pages perform a function and redirect to a user interface page. Once the authorized user is logged in, a generic toolbar is displayed on each of the user interface pages depicted in FIG. 3 to allow immediate navigation to all of the core functionalities of the web-based data warehousing site.

The login script ASP 91 validates the authorized user's login and password against the metadata database and initializes session information such as the user's color scheme, location of the user's corporate logo banner, the user's ID, and the user's name, for example. If the submitted user login and/or password are invalid, the login script 91 redirects the user back to the home page 89 and a message is displayed. If the user name and password are valid, the login script 91 allows the user in and redirects to the main menu 95.

From the main menu 95, the user can go to Administrator Account 107, date file upload 111, report generation 99, report creation 97, or log-out 93. An upload and data extraction script 117 receives the uploaded data file and initiates the Extractor COM DLL to unzip the file (if necessary), parse the files, and insert the data into the user's data mart. A report generation processing script 103 displays the generated report created by the Crystal Report Report Generation Engine 61 (FIG. 2) and displays it using the client side Crystal Reports Report Viewer ActiveX component. The report creation script 101 once a report has been designed, stores the design aspects of the report in the metadata database 59 and an RPT file is created and saved on the web server for report viewing 105 on the user interface. The log out script 93 clears all session variables for the authorized user's session to free up the resources.

The other user interface screens of FIG. 3 like the upload program 115, administrative account processing 109, data modification 113 and data modification processing 119 perform the functions states in FIG. 3.

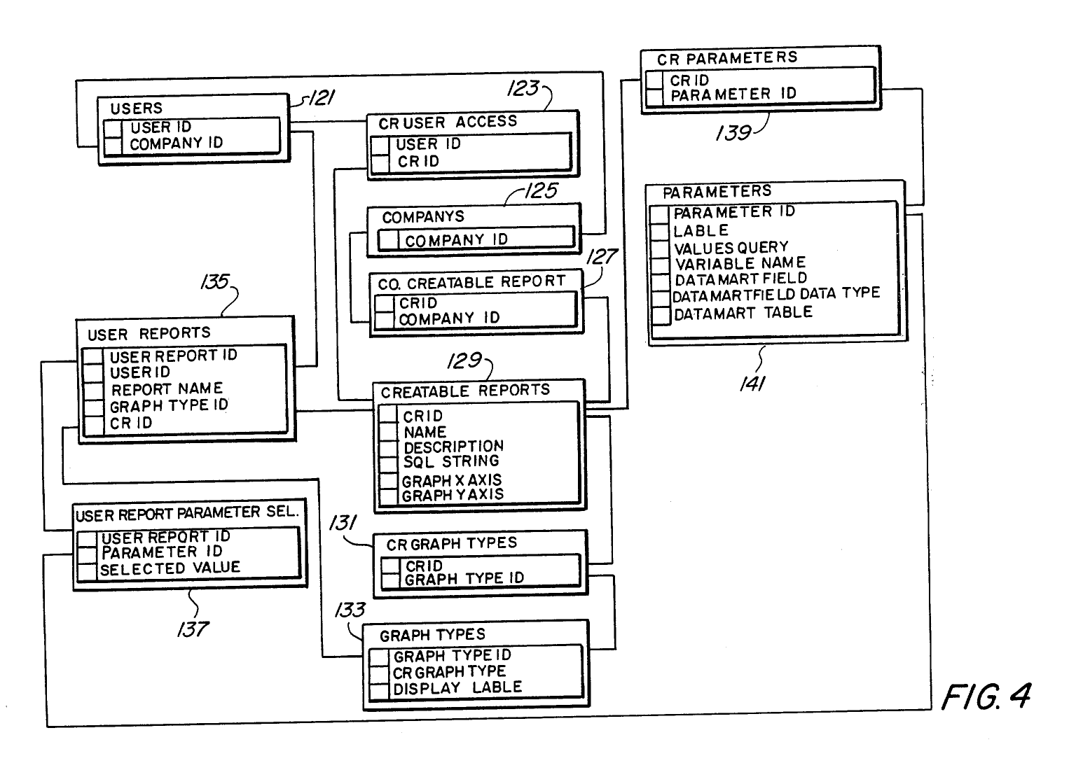

Referring now to FIG. 4, a detailed description of the metadata database schema for that portion of the metadata database storage that supports report creation is illustrated.

The user's table 121 stores information on the individual authorized users. The company that subscribes to the service is allotted a maximum number of users. Each user has personal information stored in the database such as login, password, name, address and so on. Logins for each authorized user must be unique and passwords must be at least eight digits in length. The company ID field references the company the user belongs to. The system has two levels of users, administrative and non-administrative users. Administrative authorized users are denoted by a 1 in the user level field. Non-administrative authorized users are denoted by a 0. An entry in the CR user access table 123 indicates that a user represented by a user ID has been granted the right to create the report represented by CRID which is the creatable report ID.

The company table 125 stores information about the company which is subscribing to the service. Each company has its own set of authorized users and own branded version the website. The company table 125 stores the company name, address, banner logo to display within the website, and the company's user interface color scheme.

The company creatable reports table 127 allows entry only to users that belong to the branded version of the service represented by the company ID as having the ability to create a report represented by CRID. Individual user's access to the functionality of creating the report depends on whether the administrator for the authorized user has granted access to create that report.

Entry into the CR parameters table 139 indicates that a creatable report represented by CRID supports the parameter selection of the parameter in the parameters table represented by the parameter ID. Both creatable (ad-hoc) and static reports share the parameters table.

Entry into the CR user access table 123 indicates that the user represented by the user ID has been granted the right to create the report represented by CRID.

The user reports table 135 stores information about reports that individual users have created from the creatable reports 129. Created reports are viewable only by the user who created that report as indicated by his user ID. When a user creates a report, the Crystal Reports RPT file is created on the server. Information that is difficult to retrieve from the RPT file using the CR-RDC object model is stored in the metadata database.

The creatable reports table 129 stores data on all the reports that the system is capable of creating at that time. A creatable report is simply a report type that can be customized to user specifications. A report type from an implementation standpoint is a predefined query that returns a superset of data that can be filtered down to return only a subset of data and has the capability of having the presentation modified. The SQLString field stores the query that returns the superset of data to the report. The Graph X and Graph Y fields represent the table and the column name of the x and y access of the bar chart (or the on change of, and values fields if a pie chart is chosen) associated with the report. Creatable reports have a predetermined chart associated with preset x and y axis in which the type of chart is customizable. If the Graph X Axis and the Graph Y Axis are null, the report does not support a graph.

The graph types table 133 stores all the graph types supported by the system. The most common graph types are 2D bar charts, 3D bar charts, 2D pie charts and 3D pie charts.

Entry into the CR graph type table 131 indicates that a creatable report represented by CRID supports the inclusion of a graph type represented by graph type ID.

Entry in the CR parameter table 139 indicates that the creatable report represented by CRID supports the parameter selection of the parameter in the parameter table 141 represented by the parameter ID. Both creatable and static reports share the parameters table 141.

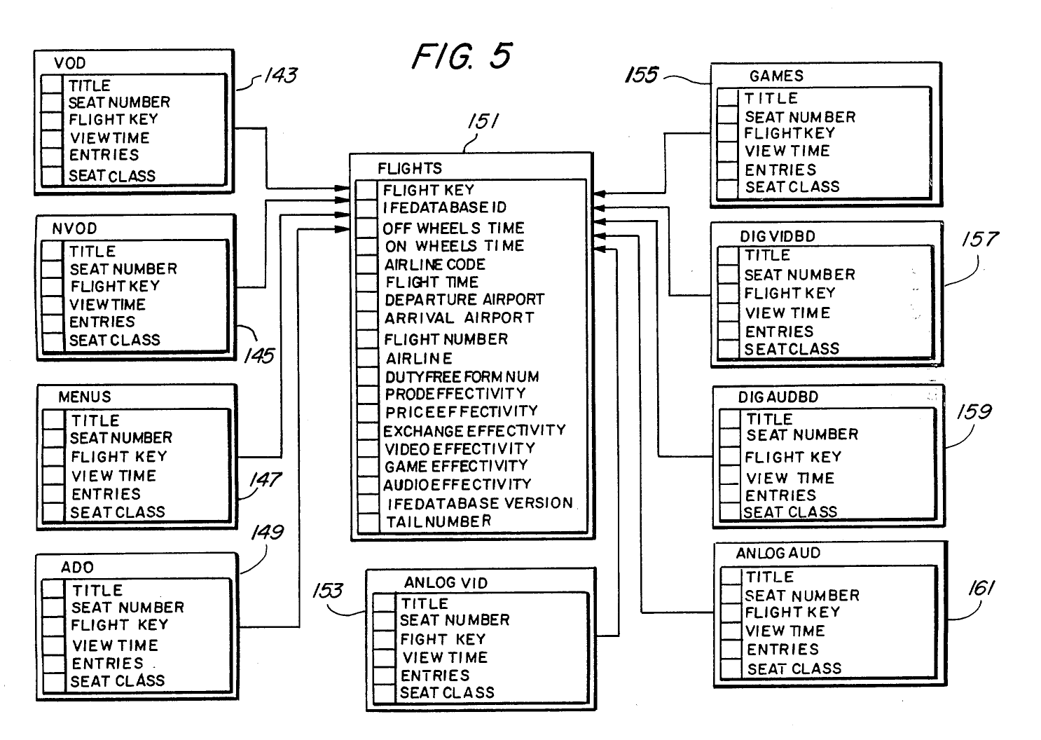

FIG. 5 illustrates the in-flight entertainment use statistics database schema. This schema is utilized to store the data that can be uploaded from an in-flight entertainment system server to track the system usage statistics.

The flights table 151 stores flight specific information such as flight number, flight time, departure airport, arrival airport, and aircraft tail number. The flight key is the primary key on this table.

The VOD table 143 stores video on demand title viewing by seat per flight. The view time field represents the number of minutes the user at a seat on the aircraft spent viewing the title. The entries field represents the number of times the user selected the given title for viewing.

The NVOD table 145 stores near video on demand title viewing by seat per flight. The view time field represents the number of minutes the user at a seat on the aircraft spent viewing the title, the entries field represents the number of times the user selected the given title for viewing.

The menus table 147 stores menu viewing by seat per flight. The view time field represents the number of minutes the user at a seat on the aircraft spent viewing the menu. The entries field represents the number of times the user selected the given menu item.

The AOD table 149 stores audio on demand type listening by seat per flight. The view time field represents the number of minutes the user at a seat on the aircraft spent listening to the title. The entries field represents the number of times the user selected the given title for listening.

The analog VID table 153 stores analog video title viewing by seat per flight. The view time field represents the number of minutes the user at a seat on the aircraft spent viewing the title. The entries field represents the number of times the user selected the given title for viewing.

The analog AUD table 161 stores analog audio title listening by seat per flight. The view time field represents the number of minutes the user at a seat on the aircraft spent listening to the title. The entries field represents the number of times the user selected the given title for listening.

The Dig Aud Bd table 159 stores broadcast digital audio title listening by seat per flight. The view time field represents the number of minutes the user at a seat on the aircraft spent listening to the title. The entries field represents the number of times the user selected the given title for listening.

The Dig Vid Bd table 157 stores broadcasted digital videotape viewing by seat per flight. The view time field represents the number of minutes the user at a seat on the aircraft spent viewing the title. The entries field represents the number of times the user selected the given title for viewing.

The games table 155 stores video game title playing per seat per flight. The view time field represents the number of minutes the user at a seat on the aircraft spent playing the title. The entries field represents the number of times the user selected the given title for playing.

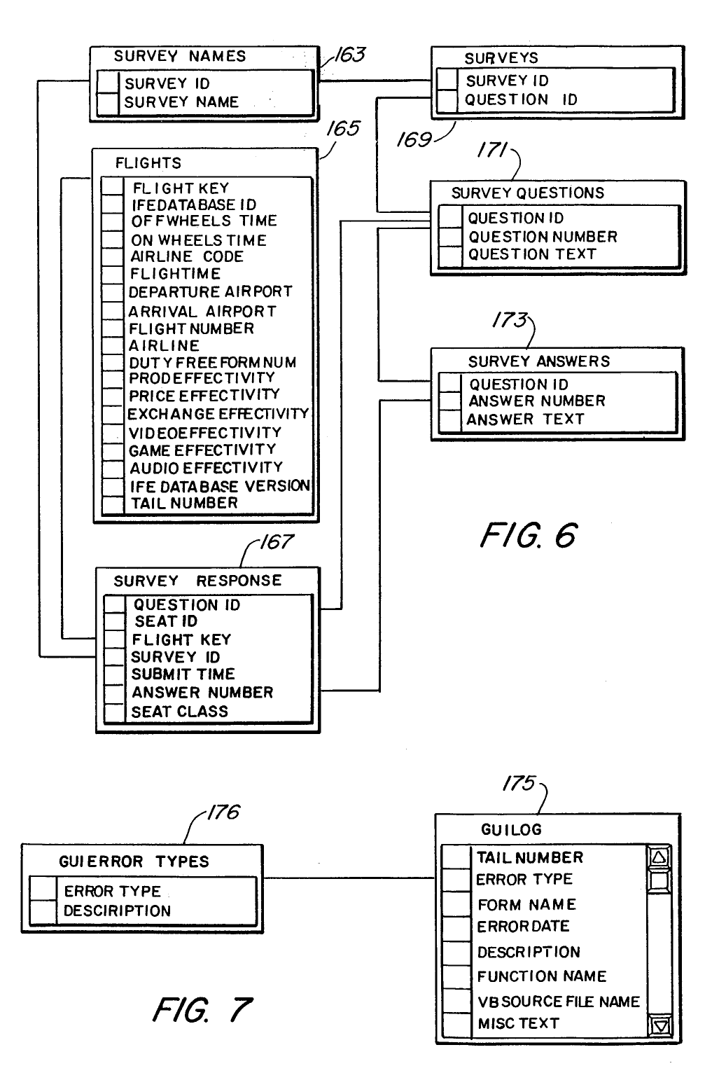

FIG. 6 represents a passenger survey database schema which stores survey questions, answers and passenger responses by seat per flight.

The Survey Names table 163 stores the name for each survey stored at an authorized user's data mart and the Surveys table 169 maps questions to surveys. For each questions in a survey, the surveys table has an entry tying the question represented by a question ID to the survey represented by the survey ID. The survey questions table 171 stores each survey question. The question number field represents the order in which the question is presented to the user and the question text field stores the actual question. A survey can have any number of questions.

The Survey Answers table 173 stores all of the possible answers to a given question. A survey can have between 2 and 6 possible answers. The answer text field is the question, answer and the answer number is the order number in which the answer is presented to the user.

The Survey Responses table 167 records the answer represented by answer number for the question represented by question ID selected by the passenger in the seat number represented by seat ID for the flight represented by the flight ID.

The flights table 165 . . . need description.

FIG. 7 is an illustration of a database schema for storing information obtained from the in-flight information system graphic user interface error log. The GUI log 175 stores errors that were logged by the in-flight information system to the graphic user interfacer log. The GUI Error Types table 176 stores the type of errors that can appear in the graphic user interfacer log 175.

Those skilled in the art will appreciate that various adaptations and modifications of the just-described preferred embodiment(s) can be configured without departing from the scope and spirit of the invention. Therefore, it is to be understood that, within the scope of the appended claims, the invention may be practiced other than as specifically described herein.

What is claimed is:

1. A system for acquiring, processing and presenting data for each authorized user of the system from information aggregated by an in-flight aircraft computer system, the system comprising:
a means for down-loading the aggregated information from the in-flight aircraft computer system;
a processor for receiving the aggregated information and extracting data of interest to the authorized user from the aggregated information;
data storage configured to uniquely store the extracted data for each authorized user; and
a data presentation processor for receiving the stored data for each authorized user and generating reports based on the received data as directed by the authorized user.

2. The system of claim 1 wherein the down-loading means comprises a portable disk storage medium.

3. The system of claim 1 further comprising a means for up-loading the down-loaded aggregate information to the receiving processor.

4. The system of claim 3 wherein said up-loading means includes a web-based user interface uniquely configured for a particular authorized user.

5. The system of claim 1 wherein the receiving processor extracts the data from the aggregated information and inserts the data into data storage according to a data format defined by the authorized user.

6. The system of claim 1 wherein said data storage comprises:
a separate database for each authorized user for storing the extracted data; and
a meta database separate from the authorized user database for storing information about each authorized user, about how to extract data from the aggregate information, and how to insert the extracted data into the authorized user's database.

7. The system of claim 1 wherein the data presentation processor generates reports based on sets of predetermined reports and authorized user customization of these predetermined reports.

8. The system of claim 1 further comprising an account administration processor for defining user access levels and effective dates for the stored extracted data.

9. The system of claim 1 further comprising a missing data reminder processor for reminding an authorized user that certain data has not been stored yet.

10. The system of claim 9 wherein the missing data reminder processor sends reminders on the basis of an authorized user's specification as to the type of data monitored, the time that can pass before notification, and the frequency of the reminders.

11. The system of claim 10 wherein the missing data processor sends the reminders to the authorized user over the internet to an e-mail address specified by the authorized user.

12. The system of claim 4 wherein the receiving processor extracts the data from the aggregated information and inserts the data into data storage according to a data format defined by the authorized user.

13. The system of claim 12 wherein said data storage comprises:
a separate database for each authorized user for storing the extracted data; and
a meta database separate from the authorized user database for storing information about each authorized user, about how to extract data from the aggregate information, and how to insert the extracted data into the authorized user's database.

14. The system of claim 13 wherein the data presentation processor generates reports based on sets of predetermined reports and authorized user customization of these predetermined reports.

15. The system of claim 14 further comprising an account administration processor for defining user access levels and effective dates for the stored extracted data.

16. The system of claim 15 further comprising a missing data reminder processor for reminding an authorized user that certain data has not been stored yet.

17. The system of claim 16 wherein the missing data reminder processor sends reminders on the basis of an authorized user's specification as to the type of data monitored, the time that can pass before notification and the frequency of the reminders.

18. The system of claim 17, wherein the missing data processor sends the reminders to the authorized user over the internet to an e-mail address specified by the authorized user.

19. A method of acquiring, processing and presenting data for an individual authorized user from information aggregated by an in-flight aircraft computer system, the method comprising:
down-loading the aggregate information from the in-flight aircraft computer system;
extracting data of interest to the individual user from the down-loaded information;
storing the extracted data in a database unique to the authorized user; and
generating reports based on the stored data as directed by the authorized user.

20. The method of claim 19 further comprising up-loading the down-loaded aggregate information over through a web-based interface.

21. The method of claim 19 wherein the extracting data steps comprises:
extracting the data;
passing the date; and
inserting the passed data into data storage according to a format defined by the authorized user.

22. The method of claim 19 wherein the generating reports step comprises utilizing one of a predetermined set of reports.

23. The method of claim 19 wherein the generating reports step comprises customizing one of a predetermined set of reports.

24. The method of claim 19 further comprising defining user access levels for an authorized user.

25. The method of claim 19 further comprising defining effective dates for the stored authorized user data.

26. The method of claim 19 further comprising reminding an authorized user that certain predetermined data has not been stored yet.

27. The method of claim 19 further comprising reminding an authorized user that certain data as predetermined by the authorized user, has not been stored yet after a time period, predetermined by the authorized user, has passed.
